(19) United States
(12) Patent Application Publication
(10) Pub. No.: US 2025/0202347 A1
(43) Pub. Date: Jun. 19, 2025

(54) CONDUCTION MODE SWITCHING FOR SWITCHING MODE POWER SUPPLY

(71) Applicant: AES Global Holdings PTE Ltd., Singapore (SG)

(72) Inventors: Transing Xing, Shenzhen (CN); Grey Qiu, Shenzhen (CN); Dragon Pan, Shenzhen (CN); Bowen Liu, Shenzhen (CN); Shicheng Peng, Shenzhen (CN)

(21) Appl. No.: 18/700,629

(22) PCT Filed: Oct. 11, 2021
(86) PCT No.: PCT/CN2021/123095

§ 371 Date: Feb. 11, 2025

(51) Int. Cl. H02M 1/42; H02M 1/00

(52) U.S. Cl. CPC H02M 1/4225; H02M 1/0009

(57) ABSTRACT

A PFC circuit comprises an inductor winding, a power switch coupled to the inductor winding, and a control circuit coupled to the power switch. The control circuit includes a zero-current detection (ZCD) controller and a mode selection circuit. The ZCD controller monitors a state of current flow through the inductor winding and controls the power switch in response to the current flow. The mode selection circuit includes a capacitor that stores energy based on the current flow and includes a mode controller configured to control a dissipation time period of the stored energy in the one or more capacitors to cause the ZCD controller to control the power switch to operate the power converter in a first conduction mode in response to a first dissipation time period and in a second conduction mode in response to a second dissipation time period greater than the first dissipation time period.

### CROSS-REFERENCE TO RELATED APPLICATIONS

This application is a 371 of and claims the benefit and priority of PCT Application No.: PCT/CN2021/123095, filed Oct. 11, 2021. The entire disclosure and contents of the above application are incorporated herein by reference.

### TECHNICAL FIELD

Aspects of the disclosure relate to power converters and more particularly to switching between power conversion conduction modes.

### BACKGROUND

Switching power converters convert an electrical power using one or more power switches. Switching power converters commonly include power factor correction (PFC) circuits to correct a power factor between an AC voltage and an AC current. The PFC circuit may be controlled to operate in one or more modes including, for example, a continuous conduction mode, a transition or critical conduction mode, and a discontinuous conduction mode.

Operation of the power converter in an operational mode such as the critical conduction mode may offer high efficiency when the input voltage or energy is above a certain supply threshold (e.g., greater than 180 Vac) and when the load is above a certain load threshold (e.g. greater than 100 W). If the input voltage is high, supplying power to a light load can reduce efficiency of the power converter. Accordingly, operating the power supply in a discontinuous conduction mode instead of a transition or continuous conduction mode can improve efficiency in high line/light load conditions.

### OVERVIEW

In accordance with one aspect of the present disclosure, a power converter comprises a power factor correction (PFC) circuit comprising an inductor winding configured to receive an input voltage, a power switch coupled to the inductor winding, and a control circuit coupled to the power switch. The control circuit is configured to control the power switch to boost the input voltage to a second voltage. The control circuit comprises a zero-current detection (ZCD) controller and a mode selection circuit coupled to the ZCD input. The ZCD controller comprises a ZCD input configured to monitor a state of current flow through the inductor winding based on a current flow signal and a ZCD output configured to control the power switch between an on state and an off state in response to the monitored state of current flow. The mode selection circuit comprises one or more capacitors configured to store energy based on the monitored state of current flow and a mode controller configured to control a dissipation time period of the stored energy in the one or more capacitors to cause the ZCD controller to control the power switch to operate the power converter in a first conduction mode in response to a first dissipation time period and in a second conduction mode in response to a second dissipation time period greater than the first dissipation time period.

In accordance with another aspect of the present disclosure, a method is provided of switching a conduction mode of a switching power supply including an inductor winding coupled to a power switch and a control circuit configured to control the power switch to boost an input voltage to an output voltage. The method comprises receiving a first signal corresponding with an amount of voltage supplied to the inductor, receiving a second signal corresponding with an amount of current supplied by the switching power supply to a load, and receiving a third signal corresponding to an amount of current flow through the inductor winding. The method also includes storing energy in a first capacitor based on the third signal, varying a dissipation time period of the energy stored in the first capacitor based on the first and second signals, and controlling the power switch from an off state to an on state in response to dissipation of the energy stored in the first capacitor falling below a first threshold.

### BRIEF DESCRIPTION OF THE DRAWINGS

The drawings illustrate embodiments presently contemplated for carrying out the invention.

In the drawings:

FIG. 1 illustrates a block diagram of a power supply according to an example.

FIG. 2 illustrates a schematic diagram of a boost converter circuit according to an example.

FIG. 3 illustrates a schematic diagram of a zero-current detection switch circuit according to an example.

FIG. 4 illustrates waveforms of a transition mode control scheme according to an example.

FIG. 5 illustrates waveforms of a discontinuous mode control scheme according to an example.

FIG. 6 illustrates a flowchart for selecting an operational mode of a boost converter circuit according to an example.

FIG. 7 illustrates a schematic diagram of a boost converter circuit according to another example.

FIG. 8 illustrates a schematic diagram of a zero-current detection switch circuit according to another example.

FIG. 9 illustrates a schematic diagram of a mode selection circuit according to another example.

FIG. 10 illustrates a schematic diagram of a mode selection circuit according to another example.

FIG. 11 illustrates a schematic diagram of a mode selection circuit according to another example.

### DETAILED DESCRIPTION

Examples of the present disclosure will now be described more fully with reference to the accompanying drawings. The following description is merely exemplary in nature and is not intended to limit the present disclosure, application, or uses.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

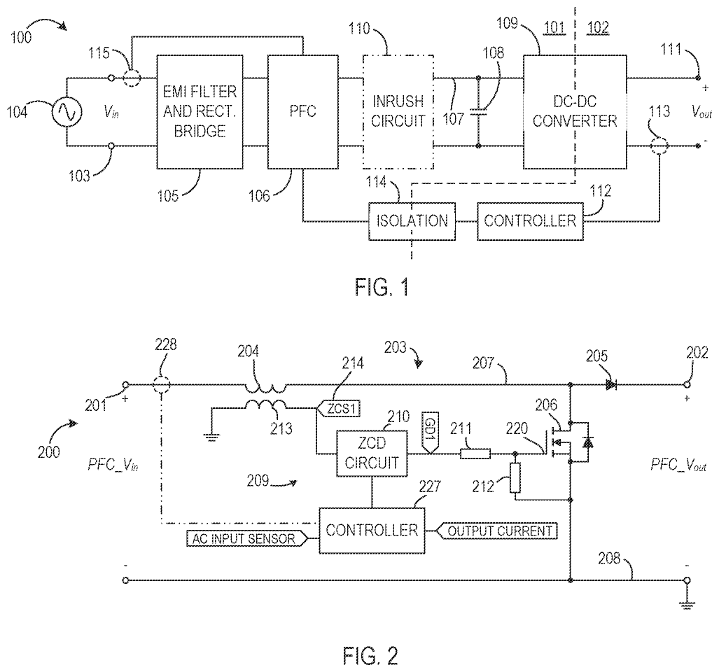

FIG. 1 illustrates a block diagram of a plurality of elements of a power supply 100 having a primary side 101 and a secondary side 102. The primary side 101 includes a voltage input 103 coupled to receive input voltage from an AC source 104 such as a power grid. An EMI filter and rectification bridge assembly 105 coupled to the voltage input 103 is configured to filter high frequency electromagnetic noise present on the voltage input 103 and to rectify an AC voltage into a DC voltage. In one embodiment, the EMI filter operates to filter electromagnetic noise on the incoming AC voltage and provide the filtered voltage to the rectification bridge for providing the DC output. A power factor correction circuit 106 such as contemplated herein is coupled to receive the DC voltage output from the rectification bridge 105 and to boost the DC voltage to a higher value for supply to a primary side voltage bus 107 coupled to a bulk capacitor 108 and to a DC-DC converter 109. An inrush circuit 110 (shown in phantom) is optionally provided to reduce the effects of current spikes in the energy provided by the PFC circuit 106. The DC-DC converter 109 may be a switched mode buck converter to convert the voltage on the primary side voltage bus 107 into a lower output voltage for supply to a load (not shown) coupled to a voltage output 111. As illustrated, the DC-DC converter 109 is coupled to both the primary side 101 and the secondary side 102 and includes one or more isolation components (not shown) for isolating the primary and secondary sides 101, 102.

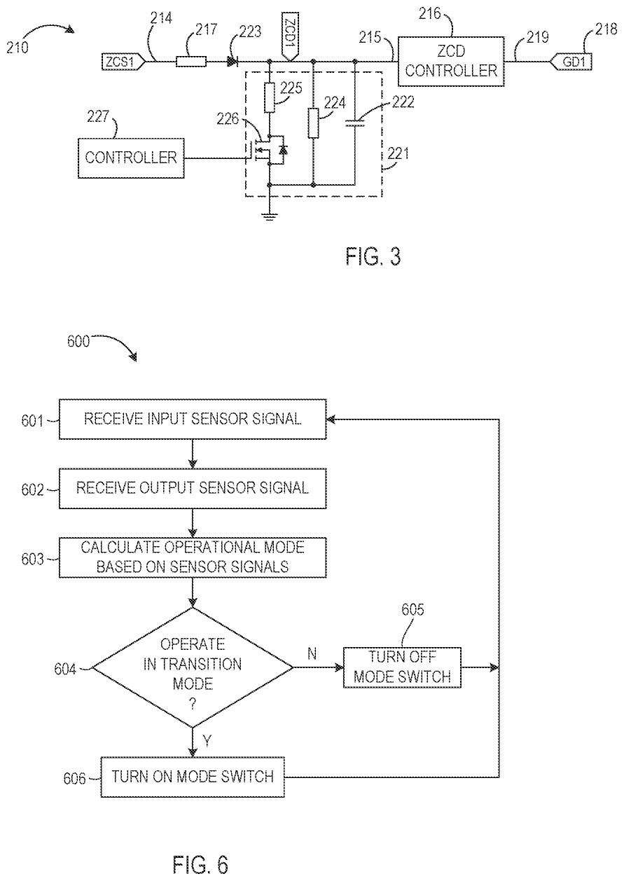

A feedback controller 112 is coupled to a current sensor 113 and is configured to provide a feedback signal to the PFC circuit 106 via an isolation component 114 indicating a value of the output current. An input sensor 115 configured to sense a voltage or current of the incoming AC voltage may be coupled to provide the sensed voltage/current to the PFC circuit 106. As described herein, the feedback signals based on the output current and the input voltage and/or current are used to control a zero-current detection (ZCD) switch (FIG. 3) for controlling a conduction mode of the PFC circuit 106.

FIG. 2 illustrates a boost converter circuit 200 for the PFC circuit 106 of FIG. 1 according to an example. The boost converter circuit 200 includes a DC voltage input 201 and a DC voltage output 202. The DC voltage input 201 is coupled to receive the DC output voltage from the EMI filter 105 of FIG. 1, and the DC voltage output 202 is coupled to supply a DC output voltage to the bulk capacitor 108 (or to the inrush circuit 110 if included) of FIG. 1. Between the DC voltage input 201 and DC voltage output 202, a boost circuit 203 is configured to boost the input voltage and correct the power factor of the voltage to reduce harmonic distortion and reduce a phase shift between the voltage and current supplied to the power supply 100 (FIG. 1). The boost circuit 203 includes an inductor 204 coupled in series with a rectifying device (e.g., a diode) 205 between the DC voltage input and output 201, 202. A controllable power switch 206 (e.g., a metal-oxide semiconductor field effect transistor (MOSFET)) is coupled between a positive voltage node 207 coupling the inductor 204 in series with the diode 205 and a second voltage node 208 such as a ground node. Through appropriate control of the conduction and non-conduction modes of the switch 206, the boost circuit 203 boosts the DC input voltage on the DC voltage input 201 to a higher DC voltage for output by the DC voltage output 202.

Referring to FIGS. 2 and 3 according to one example, a control circuit 209 is coupled to the boost circuit 203 to control the conduction modes of the switch 206. The control circuit 209 includes a ZCD detector circuit 210 coupled to the switch 206 via one or more resistors 211, 212 for controlling the switch 206 into conduction and non-conduction states. The ZCD circuit 210 is also coupled to an inductor 213 that inductively couples with the inductor 204 to provide the ZCD circuit 210 with a signal (ZCD1) 214 indicative of the current flowing through the inductor 204. In one embodiment, the inductors 204, 213 form respective primary and secondary windings of a transformer, and are arranged in a flyback configuration. The signal 214 is provided to a ZCD input 215 of a ZCD controller 216. In one example, the ZCD controller 216 is a transition-mode controller configured to control the boost converter circuit 200 so that the inductor 204 works at or near the boundary between the continuous mode and the discontinuous mode. The transition conduction mode is also known as a critical conduction mode or boundary conduction mode. Examples of suitable ZCD controllers are the UCC28061 controller available from Texas Instruments Incorporated and the NCP1606 or FAN7930 controllers available from Semiconductor Components Industries, LLC.

In the transition mode, the boost converter circuit 200 operates in two phases. During a first phase, current is generated in the inductor 204 in response to the switch 206 operating in a conduction state. The inductor current ideally grows linearly from no current to a maximum current flow for the first phase. During a second phase in which the switch 206 is in a non-conduction state, the inductor current decreases linearly from the maximum current flow to zero current. In response to reaching zero current in the second phase, the first phase is again entered into and performed without delay in an example. The amplitude of the maximum current flow may be adjusted according to desired output voltage. The signal 214 is, therefore, provided to the ZCD controller 216 for detecting the zero-current flow through the inductor 204.

A series resistor 217 limits current of the signal 214 delivered to the ZCD controller 216. In one example, in response to the inductor current in the inductor 213 dropping to zero or near-zero values as indicated by the signal 214 during the second phase, the zero current detection input 215 drops below the zero-current threshold. As a result, the first phase is triggered, and the ZCD controller 216 controls the switch 206 into its on state via a gate drive signal (GD1) 218 on a gate drive output 219 of the ZCD circuit 210 coupled to the resistor 211 and a control input 220 of the switch 206.

A high boost efficiency can be realized by operating the boost converter circuit 200 in the transition mode while receiving a high line input (e.g., 180-264 Vac) into the voltage input 103 and delivering a sufficient output power (e.g., greater than about 100 W) to a load. However, if the load is a light load (e.g., less than about 100 W), a reduction in the efficiency may result. In a high line input/light load condition, efficiency may be improved by operating the boost converter circuit 200 in the discontinuous mode, which delays turning on the switch 206 after the current through the inductor 204 has been depleted.

As stated above, the ZCD controller 216 is configured to control the boost converter circuit 200 to operate in the transition mode. Therefore, the ZCD controller 216 is not configured to delay controlling the switch 206 into its on state in response to the current through the inductor 204 falling below the zero-current threshold. According to aspects of the disclosure, a mode selection circuit 221 is coupled to the ZCD input 215 and configured to condition the signal 214 according to a desired operational mode (e.g., transition conduction mode or discontinuous conduction mode) of the boost converter circuit 200. The mode selection circuit 221 is configured to switch between various delay modes for controlling the decay or falling of the signal 214 to a value at or below the zero-current threshold. In this manner, the effects of conditioning the signal 214 allow the boost converter circuit 200 to operate in either the transition mode or the discontinuous mode as described herein even while the ZCD controller 216 continues to operate according to its configuration of operating in the transition mode only. The transition mode operation of ZCD controller 216 is, therefore, unmodified even when the current flowing through the inductor 204 is discontinuous.

The mode selection circuit 221 includes a capacitor 222 coupled between the ZCD input 215 and a signal ground and stores a charge based on the signal 214 flowing to the ZCD input 215. During the first phase when the ZCD controller 216 controls the switch 206 into its on state, current through the inductor 204 begins to increase. A series diode 223 blocks a reverse flow of current to the signal ground through the inductor 213. Since the inductors 204, 213 are connected in a flyback configuration, the diode 223 is reverse-biased during the first phase as the current through the inductor 204 increases. Accordingly, current flow through the inductor 213 remains off. During the second phase when the ZCD controller 216 controls the switch 206 into its off state, current through the inductor 204 begins to decrease, and current through the inductor 213 begins at a peak value and flows through the diode 223 in a forward-biased flow as it ramps down to zero. A first resistor 224 coupled in parallel with the capacitor 222 provides a first path for a voltage (e.g., ZCD1) to be generated by the forward current as it charges the capacitor 222. The ZCD1 voltage is available to the ZCD input 215 for comparison with the zero-current threshold to determine when to transition back to the first phase. When the forward current decreases beyond a value sufficient to generate a voltage through the first resistor 224 greater than or equal to the energy stored in the capacitor 222, the diode 223 again becomes reverse-biased, and the first resistor 224 provides a path that allows the stored charge in the capacitor 222 to dissipate back to the signal ground. In response to dissipation of the stored charge, the ZCD1 voltage decreases, and the ZCD controller 216 compares the falling voltage with the zero-current threshold to determine when to transition back to the first phase. For example, the zero-current threshold may be represented by a voltage threshold below which the current flow through the inductor 204 is deemed to be zero.

The mode selection circuit 221 also includes a series-connected second resistor 225 and switch 226 that are coupled in parallel with the first resistor 224. When controlled into its on state, the switch 226 provides a second path in parallel with the first path for generation of a portion of the ZCD1 voltage during the forward current flow and for dissipation of a portion of the stored charge in the capacitor 222 when the diode 223 becomes reverse-biased. When controlled into its off state, the switch 226 prevents the second path from contributing to voltage generation or dissipation of the stored charge, and the voltage is generated and the stored charge is dissipated through the first path only and not through both of the first and second paths. Based on a value of the first and second resistors 224, 225, the value of the ZCD1 voltage generated and the time period of dissipation of the stored charge may be optimized. In one example, the resistance value of the first resistor 224 is higher than the resistance value of the second resistor 225. The resistance value of the first resistor 224 can be much higher than the resistance value of the second resistor 225 in an example. Accordingly, a higher voltage and a slower dissipation time period may be achieved by controlling the switch 226 into its off state such that the charging current and stored charge flow through the larger resistor of the first path. A faster dissipation time period may be achieved by controlling the switch 226 into its on state such that the charging current and stored charge flow through both resistors 224, 225.

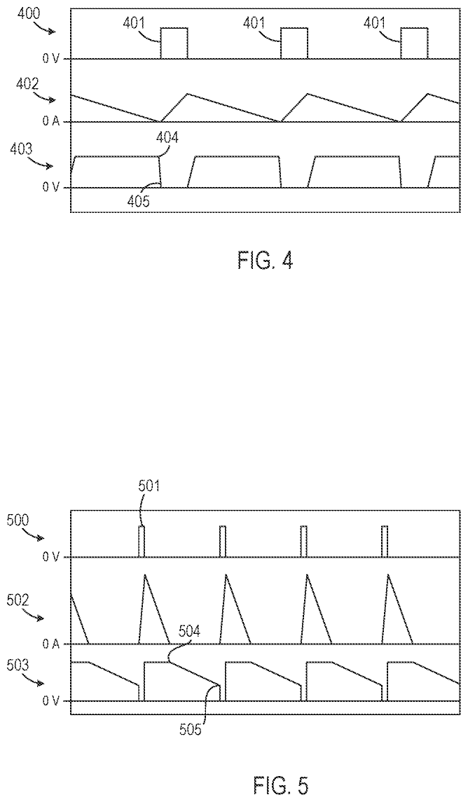

In being controlled into its on state, the switch 226 allows the stored charge to fall below the zero-current threshold at a faster time than the dissipation time while the switch 226 is in its off state. In one example, the faster dissipation time allows the ZCD controller 216 to transition back to the first phase such that the current through the inductor 204 flows at or near the transition mode of operation. That is, all or substantially all of the current flowing through the inductor 204 is dissipated as the ZCD controller 216 transitions to the first phase to command the switch 206 into its on state. FIG. 4 illustrates example waveforms associated with this example. A first pulse signal waveform 400 illustrates gate drive signal pulses 401 output by the ZCD controller 216 to control the switch 206 into its on state. Between the pulses 401, the switch 206 is controlled into its off state. During the pulses 401, current begins to flow through the inductor 204 and increases until the switch 206 is turned off at the end of the pulse 401 as illustrated in the current waveform 402 of the inductor 204. Current that is induced in the inductor 213 by the inductor 204 generates a ZCD voltage 403 provided to the ZCD input 215 of the ZCD controller 216. The ZCD voltage 403 charges the capacitor 222. In response to a reverse biasing of the diode 223 (e.g., point 404), the ZCD1 voltage reduces in step with the dissipation of the stored energy in the capacitor 222. The ZCD controller 216, which is programmed to detect a falling edge of the ZCD1 voltage, detects the falling edge of the ZCD voltage 403 in response to the voltage 403 arriving at and/or falling below a minimum voltage threshold such as at point 405, for example. In response to detecting the falling edge, the ZCD controller 216 transmits the next gate drive signal pulse 401 to command the switch 206 into its on state such that the switch 206 turns on and causes the current 402 to begin rising again through the inductor 204. As illustrated, the turning on of the switch 206 allows the boost converter circuit 200 to operate at or near the transition mode. Increasing or decreasing the resistance of the first resistor 224 in addition to selecting appropriate values of the other circuit components can lengthen or shorten the dissipation time of the stored current in the capacitor 222 to optimize the time at which the point 405 is reached.

Referring back to FIG. 3, in being controlled into its off state, the switch 226 prevents dissipation of the charge stored in the capacitor 222 to flow through the second resistor 225. Accordingly, the stored charge is dissipated through the first resistor 224, which, having a higher resistance value than the second resistor 225 in one example, provides a slower dissipation time. Thus, in response to a loss of current flow through the diode 223 to charge the capacitor 222, the capacitor 222 can begin to discharge its stored current through the first resistor 224. The slow dissipation through the first resistor 224 extends a time in which a voltage created by the stored current flowing through the first resistor 224 remains above the zero-current threshold. FIG. 5 illustrates example waveforms associated with this example. A pulse signal waveform 500 illustrates gate drive signal pulses 501 output by the ZCD controller 216 to control the switch 206 into its on state. Between the pulses 501, the switch 206 is controlled into its off state. During the pulses 501, current begins to flow through the inductor 204 and increases until the switch 206 is turned off at the end of the pulse 501 as illustrated in the current waveform 502 of the inductor 204. Current that is induced in the inductor 213 by the inductor 204 generates a ZCD voltage 503 provided to the ZCD input 215 of the ZCD controller 216 that charges the capacitor 222. In response to a reverse biasing of the diode 223 (e.g., point 504), the ZCD1 voltage reduces in step with the dissipation of the stored energy in the capacitor 222. Compared with the delay between points 404, 405 of FIG. 4, the delay after point 504 of FIG. 5 in which the stored energy in the capacitor 222 dissipates sufficiently to reach point 505 is increased. During this delay, the current through the inductor 204 has been exhausted and is insufficient to produce an output voltage at the output 202 of the boost circuit 203. As a result, the operation of the boost converter circuit 200 is in the discontinuous mode though the ZCD controller 216 is configured to switch to the first phase in short response after detecting the falling edge. As illustrated in the example of FIG. 5, current flow through the inductor 204 may be off for a longer period than it is on. However, the duty cycle of the current on time to the total time between pulses 501 is controllable to adjust the high input voltage to an appropriate output voltage for the light load.

As illustrated in FIGS. 2 and 3, a mode controller 227 is coupled to the switch 226 and configured to control the switch 226 into its on and off states. The mode controller 227 further receives a signal from the output current sensor 113 and a signal from an input voltage sensor 228 configured to sense a voltage input into the boost converter circuit 200 via the DC voltage input 201. Alternatively or in conjunction with the signal from the input voltage sensor 228, the mode controller 227 may receive a signal from the input sensor 115. Based on the signals from the sensors 113, 228 (and/or sensor 115), the mode controller 227 may set the operational mode of the boost converter circuit 200 by turning the switch 226 on or off.

FIG. 6 illustrates a procedure 600 for choosing and selecting an operational mode of the boost converter circuits described herein according to an example. At block 601, the mode controller 227 receives an input sensor signal based on one or more of the input voltage sensor 228 and the input sensor 115. A signal from the output current sensor 113 is received at block 602. Based on the received sensor signals, the operational mode of the boost converter circuit is calculated at block 603. In one example, the received input and output sensor signals may be compared with respective thresholds stored in memory, stored in a lookup table, supplied as voltage or current references, etc. The mode controller 227 may, for example, determine that the input voltage supplied via the AC source 104 is in a range of 180 to 264 VAC and that the load is drawing less than 100 W. In this case, operation of the boost converter circuit 200 in the transition mode causes a loss of efficiency in the system. Accordingly, the mode controller 227 may determine that operation in the discontinuous mode is appropriate at block 604 and control the switch 226 into its off state (block 605) such that the boost converter circuit 200 operates in the discontinuous mode as described herein. In response to determining that operation of the boost converter circuit 200 at or near the transition mode is desired to improve efficiency (e.g., the load is drawing greater than 100 W), the mode controller 227 may control the switch 226 into its on state (block 606) such that the boost converter circuit 200 operates at or near the transition mode as described herein. The procedure 600 may return to block 601 after turning the mode switch on or off so that the mode controller 227 may react to subsequent changes in circuit conditions that benefit from changing the operational mode.

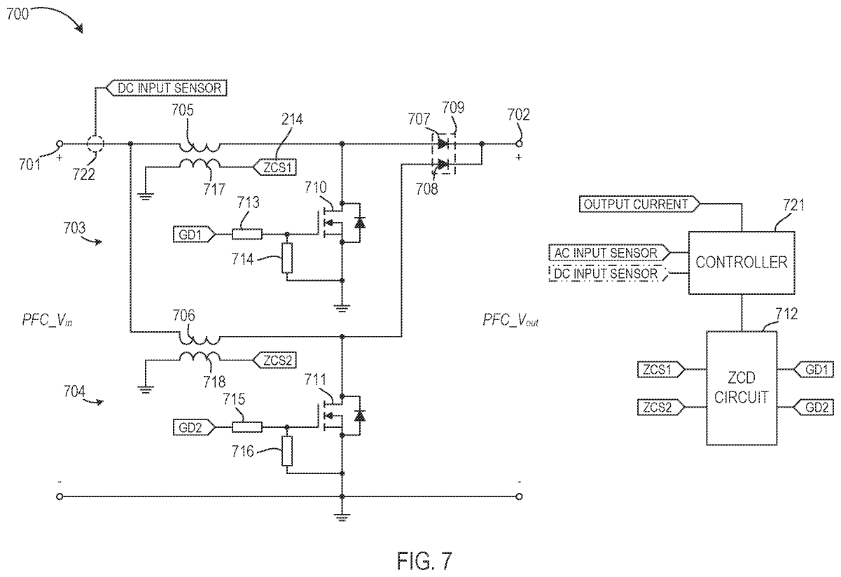

FIG. 7 illustrates a boost converter circuit 700 for the PFC circuit 106 of FIG. 1 according to another example. The boost converter circuit 700 includes a DC voltage input 701, a DC voltage output 702, and a pair of boost circuits 703, 704 arranged in an interleaved manner coupled between the DC voltage input 701 and the DC voltage output 702. The boost circuits 703, 704 may be similar or identical circuits as boost circuit 203 described herein. For example, each boost circuit 703, 704 may include an inductor 705, 706 coupled in series with a rectifying device (e.g., a diode) 707, 708 of a rectifier assembly 709 between the DC voltage input and output 701, 702. Each circuit 703, 704 includes a controllable switch 710, 711 (e.g., MOSFET) coupled between the respective inductor 705, 706 and ground.

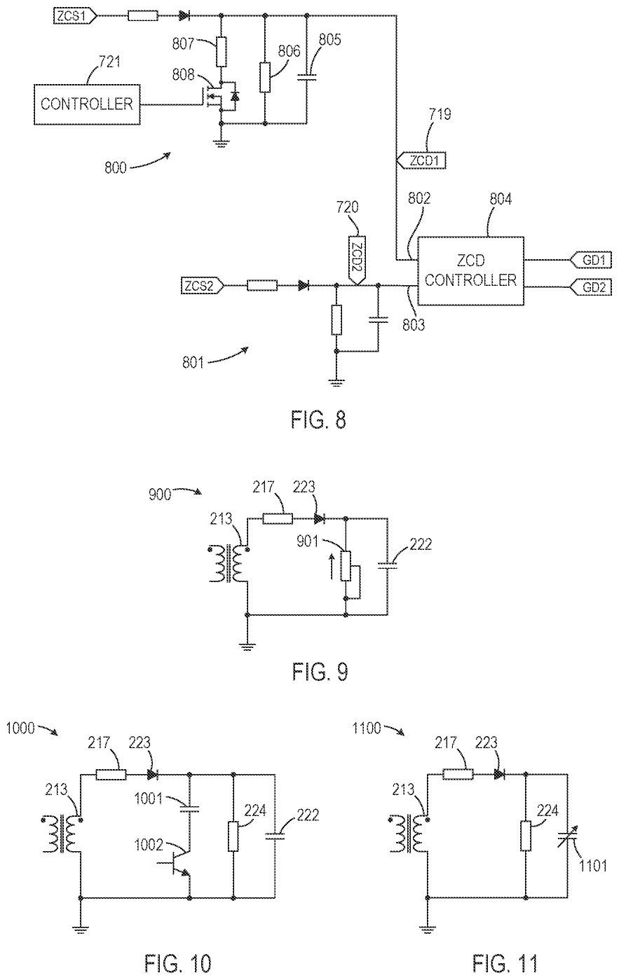

The ZCD controllers of the ZCD circuits described herein may be an interleaving transition-mode PFC controller (e.g., the UCC28061 controller) capable of controlling a single boost circuit such as described above with respect to boost circuit 203 and capable of controlling a pair of boost circuits such as boost circuits 703, 704 connected in an interleaved arrangement such as described with respect to FIGS. 7, 8. Accordingly, as shown in FIGS. 7 and 8, the ZCD detector circuit 712 is coupled to the switches 710, 711 via resistors 713-716 for independently controlling the switches 710, 711 into conduction and non-conduction states. The ZCD circuit 712 is coupled to inductors 717, 718 that inductively couple with respective inductors 705, 706 to provide the ZCD circuit 712 with signals (ZCD1, ZCD2) 719, 720 indicative of the current flowing through the inductors 705, 706. The inductors 705, 717 may form respective primary and secondary windings of a pair of one transformer, and the inductors 706, 718 may form respective primary and secondary windings of another transformer.

In the ZCD circuit 712 of FIG. 8, independent ZCD input circuits 800, 801 are coupled to ZCD inputs 802, 803 of the ZCD controller 804. The ZCD input circuit 800 may be similar to the mode selection circuit 221 shown in FIG. 3 including a capacitor 805 coupled in parallel with a first resistor 806 and in parallel with a series-connected resistor 807 and switch 808 pair. In this manner, the ZCD input circuit 800 operates to control an operational mode of the boost converter circuit 700 by controlling a charging voltage and a dissipation time of the charge stored in the capacitor 805 in a similar manner as described herein with respect to the mode selection circuit 221. In one embodiment, the ZCD input circuit 800 allows for mode selection through the use of a mode controller 721 while the ZCD input circuit 801 omits the series-connected switch/resistor pair of the ZCD input circuit 800. Accordingly, in response to determining that the discontinuous mode is preferred based on operating conditions, the ZCD controller 804 may be also instructed to pause sending gate signals GD2 to the boost circuit 704 during the high line/light load condition responsible to influencing operation in the discontinuous mode. As illustrated in FIGS. 7 and 8, the mode controller 721 receives feedback signals from the sensors 113, 722 (and/or sensor 115) and sets the operational mode of the boost converter circuit 700 such as by executing the procedure 600.

As described herein, the mode selection circuits 221, 800 alter a charging voltage and a dissipation time of capacitor-based stored energy by enabling or disabling an additional resistance path through which the stored energy may dissipate. FIGS. 9-11 illustrate additional examples of mode selection circuits usable in the boost converter circuits disclosed herein for altering a dissipation time of the energy stored in the respective storage capacitors. FIG. 9 illustrates a mode selection circuit 900 including the inductor 213, diode 223, series resistor 217, and capacitor 222 of the boost converter circuit 200. The mode selection circuit 900 provides control of charging voltage and dissipation rates of the energy stored in the capacitor 222 via a variable resistor 901 controllable, in one example, by the mode controller 227 of FIG. 3. The variable resistor 901 may be, for example, a digital potentiometer. In response to determining that the operational mode of the boost converter circuit is better in the transition mode, the mode controller may control the variable resistor 901 to a lower resistance value. In response to determining the operational mode of the boost converter circuit is better in the discontinuous mode, the mode controller may control the variable resistor 901 to a higher resistance value.

FIG. 10 illustrates a mode selection circuit 1000 including the inductor 213, diode 223, series resistor 217, resistor 224, and capacitor 222 of the boost converter circuit 200. Coupled in parallel with the resistor 224 and with the capacitor 222 is a series-coupled second capacitor 1001 and switch 1002 pair. The switch 1002 may be a MOSFET as described above or may be another type of switch such as a bipolar junction transistor (BJT) as illustrated. When controlled into its on state, the switch 1002 provides a second path for capacitive energy to be stored in addition to the capacitor 222. The additional capacitance alters (e.g., increases) the dissipation time but does not alter the charging voltage. Increasing the stored energy delays the falling edge detection by the ZCD controller 216 and, therefore, allows the energy stored in the inductor 204 to dissipate fully and operate the boost converter circuit 200 in the discontinuous conduction mode. In its off state, the switch 1002 prevents the second capacitor 1001 from storing additional energy and causes the ZCD controller 216 to operate the boost converter circuit 200 at or near the transition conduction mode.

FIG. 11 illustrates a mode selection circuit 1100 including the inductor 213, diode 223, series resistor 217, and resistor 224 of the boost converter circuit 200. The mode selection circuit 1100 provides control of dissipation times, but not charging voltage, of the energy stored in a variable capacitor 1101, which is controllable, in one example, by the mode controller 227 of FIG. 3. In response to determining the operational mode of the boost converter circuit to be better at or near the transition mode, the mode controller may control the variable capacitor 1101 to a lower capacitance value. In response to determining the operational mode of the boost converter circuit to be better in the discontinuous mode, the mode controller may control the variable capacitor 1101 to a higher capacitance value. The mode selection circuit 1100 as well as the mode selection circuits 900, 1000 are usable as alternative circuits in either of the boost converter circuits 200, 700 described herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the invention is not to be seen as limited by the foregoing description but is only limited by the scope of the appended claims.

What is claimed is:

1. A power converter comprising:
a power factor correction (PFC) circuit comprising:
an inductor winding configured to receive an input voltage;
a power switch coupled to the inductor winding; and
a control circuit coupled to the power switch and configured to control the power switch to boost the input voltage to a second voltage, the control circuit comprising:
a zero-current detection (ZCD) controller comprising:
a ZCD input configured to monitor a state of current flow through the inductor winding based on a current flow signal; and
a ZCD output configured to control the power switch between an on state and an off state in response to the monitored state of current flow; and
a mode selection circuit coupled to the ZCD input and comprising:
one or more capacitors configured to store energy based on the monitored state of current flow; and
a mode controller configured to control a dissipation time period of the stored energy in the one or more capacitors to cause the ZCD controller to control the power switch to operate the power converter in a first conduction mode in response to a first dissipation time period and in a second conduction mode in response to a second dissipation time period greater than the first dissipation time period.

2. The power converter of claim 1, wherein the ZCD output is configured to:
control the power switch into the on state during a first phase to cause current to flow through the inductor winding and through the power switch; and
control the power switch into the off state during a second phase to prevent current flow through the power switch.

3. The power converter of claim 2, wherein the ZCD controller is configured to transition from the second phase to the first phase in response to detecting the current flow through the inductor winding during the second phase to be lower than a zero-current threshold to control the power switch into the on state.

4. The power converter of claim 3, wherein the first dissipation time period causes the ZCD controller to transition from the second phase to the first phase at or near a cessation of the current flow through the inductor winding.

5. The power converter of claim 4, wherein the first conduction mode comprises a transition conduction mode.

6. The power converter of claim 3, wherein the second dissipation time period causes the ZCD controller to transition from the second phase to the first phase after a cessation of the current flow through the inductor winding.

7. The power converter of claim 6, wherein the first conduction mode comprises a discontinuous conduction mode.

8. The power converter of claim 1, wherein the one or more capacitors comprises a variable capacitor; and
wherein the mode controller is configured to control the dissipation time period of the stored energy in the variable capacitor by varying a capacitance of the variable capacitor.

9. The power converter of claim 1, wherein the mode selection circuit further comprises:
a first resistor coupled in parallel with the one or more capacitors;
a second resistor coupled in series with a switch;
wherein the second resistor and the switch are coupled in parallel with the first resistor and with the one or more capacitors; and
wherein the mode controller is configured to control the dissipation time period by controlling the switch between an on state and an off state.

10. The power converter of claim 1, wherein the mode selection circuit further comprises:
a variable resistor coupled in parallel with the one or more capacitors; and
wherein the mode controller is configured to control the dissipation time period of the stored energy in the one or more capacitors by varying a resistance of the variable resistor.

11. The power converter of claim 1, wherein the one or more capacitors comprises a first capacitor; and
wherein the mode selection circuit further comprises:
a resistor coupled in parallel with the first capacitor;
a second capacitor coupled in series with a switch;
wherein the second resistor and the switch are coupled in parallel with the first capacitor and with the resistor; and
wherein the mode controller is configured to control the dissipation time period by controlling the switch between an on state and an off state.

12. A method of switching a conduction mode of a switching power supply including an inductor winding coupled to a power switch and a control circuit configured to control the power switch to boost an input voltage to an output voltage, the method comprising:
receiving a first signal corresponding with an amount of voltage supplied to the inductor;
receiving a second signal corresponding with an amount of current supplied by the switching power supply to a load;
receiving a third signal corresponding to an amount of current flow through the inductor winding;
storing energy in a first capacitor based on the third signal;
varying a dissipation time period of the energy stored in the first capacitor based on the first and second signals; and
controlling the power switch from an off state to an on state in response to dissipation of the energy stored in the first capacitor falling below a first threshold.

13. The method of claim 12, wherein the first threshold comprises a zero-current threshold.

14. The method of claim 12, wherein the switching power supply further includes a zero-current detection (ZCD) controller configured to control the power switch from the off state to the on state in response to dissipation of the energy stored in the first capacitor falling below the first threshold.

15. The method of claim 14, wherein varying the dissipation time period comprises lengthening the dissipation time period to cause the ZCD controller to control the power switch from the off state to the on state after cessation of the current flow through the inductor winding by a first delay.

16. The method of claim 15, wherein varying the dissipation time period comprises shortening the dissipation time period to cause the ZCD controller to control the power switch from the off state to the on state at or near cessation of the current flow through the inductor winding.

17. The method of claim 14, wherein the switching power supply further includes a mode selection circuit coupled to the ZCD controller and comprising a series-coupled resistor and switch, the first capacitor coupled in parallel with the series-coupled resistor and switch, a first resistor coupled in series with the first capacitor, and a mode controller configured to vary the dissipation time period; and
wherein varying the dissipation time period of the energy stored in the first capacitor comprises controlling the switch between an on state and an off state.

18. The method of claim 14, wherein the switching power supply further includes a mode selection circuit coupled to the ZCD controller and comprising a series-coupled capacitor and switch, the first capacitor coupled in parallel with the series-coupled capacitor and switch, a first resistor coupled in series with the first capacitor, and a mode controller configured to vary the dissipation time period; and
wherein varying the dissipation time period of the energy stored in the first capacitor comprises controlling the switch between an on state and an off state.

19. The method of claim 14, wherein the switching power supply further includes a mode selection circuit coupled to the ZCD controller and comprising a variable resistor, the first capacitor coupled in parallel with the variable resistor, and a mode controller configured to vary the dissipation time period; and
wherein varying the dissipation time period of the energy stored in the first capacitor comprises varying a resistance of the variable resistor.

20. The method of claim 14, wherein the switching power supply further includes a mode selection circuit coupled to the ZCD controller and comprising the first capacitor, a resistor coupled in parallel with the first capacitor, and a mode controller configured to vary the dissipation time period;
wherein the first capacitor is a variable capacitor; and
wherein varying the dissipation time period of the energy stored in the first capacitor comprises varying a capacitance of the variable capacitor.
